(19) United States
(12) Patent Application Publication
(10) Pub. No.: US 2022/0009802 A1
(43) Pub. Date: Jan. 13, 2022

(54) ION REMOVAL KIT

(71) Applicant: KYUNGDONG NAVIEN CO.,LTD., Gyeonggi-do (KR)

(72) Inventors: Soo Young LEE, Seoul (KR); Seung Kil SON, Seoul (KR)

(21) Appl. No.: 17/295,268

(22) PCT Filed: Nov. 8, 2019
(86) PCT No.: PCT/KR2019/015210

§ 371 Date: May 19, 2021

(30) Foreign Application Priority Data
Nov. 20, 2018 (KR) 10-2018-0143475

(51) Int. Cl. C02F 1/469; C02F 5/08

(52) U.S. Cl. CPC C02F 1/4695; C02F 2209/10; C02F 2201/005; C02F 5/08

(57) ABSTRACT

An ion removal kit according to the present invention comprises: a kit case; a filter unit, which is provided inside the kit case, receives raw water from a main flow path for supplying the raw water to a water-requiring place so as to remove, through electrodeionization, at least some of ionic substances included in the received raw water, thereby discharging soft water containing less ionic substances than raw water; a filter flow path which is provided inside the kit case; and a control part which is provided inside the kit case and which controls the filter unit.

### TECHNICAL FIELD

The present disclosure relates to an ion removal kit for removing ionic substances contained in water.

### BACKGROUND ART

Ionic substances such as calcium ions (Ca²⁺), magnesium ions (Mg²⁺), and the like are contained in general tap water. Water containing ionic substances may cause damage to skin or fiber. Furthermore, calcium ions (Ca²⁺) may be precipitated as calcium carbonate (CaCO₃) by heat, or in a space due to bubbles generated by heat. The precipitated calcium carbonate (CaCO₃) may be stuck to a pipe through which water flows. The sticking of the calcium carbonate may cause non-uniform heat transfer to generate local overheating, and the local overheating may generate cracks in the pipe or a heat exchanger due to thermal stress. This leads to deterioration in durability or a decrease in lifetime in a device using a pipe through which tap water flows. Moreover, when hard water containing ionic substances is supplied for face washing, soap may not lather in the hard water, or the hard water may cause skin irritation.

Accordingly, a water softening device for removing ionic substances from water containing the ionic substances is used, and a device for softening tap water is integrally provided in a water-heating device such as a boiler. However, in order to use such a water softening device, entire piping has to be replaced, or a water-heating device has to be replaced with a new water-heating device including a water softening device.

### DISCLOSURE

### Technical Problem

The present disclosure has been made to solve the above-mentioned problems. An aspect of the present disclosure provides an ion removal kit for removing ionic substances from raw water that is supplied to a consumption site not having a means for removing ionic substances, or circulates in a state in which such a means is not provided.

### Technical Solution

An ion removal kit according to an embodiment of the present disclosure includes a kit case, a filter unit that is provided inside the kit case and that receives raw water from a main line for supplying the raw water to a consumption site, removes at least a part of ionic substances contained in the received raw water by electro-deionization, and releases soft water containing a smaller amount of ionic substances than the raw water, a filter line that is provided inside the kit case and that connects the filter unit and a water inlet opening that is formed in the kit case and through which the raw water is supplied, a water outlet line that is provided inside the kit case and that connects the filter unit and a water outlet opening that is formed in the kit case and through which the soft water is delivered to the main line, and a controller that is provided inside the kit case and that controls the filter unit.

An ion removal kit according to another embodiment of the present disclosure includes a kit case, a filter unit that is provided inside the kit case and that receives raw water from a main line for supplying the raw water to a water-heating device for heating water and circulating or releasing the heated water, removes at least a part of ionic substances contained in the received raw water by electric force, and releases soft water containing a smaller amount of ionic substances than the raw water, a filter line that is provided inside the kit case and that connects the filter unit and a water inlet opening that is formed in the kit case and through which the raw water is supplied, a water outlet line that is provided inside the kit case and that connects the filter unit and a water outlet opening that is formed in the kit case and through which the soft water is delivered to the main line, and a controller that is provided inside the kit case and that controls the filter unit.

An ion removal kit according to another embodiment of the present disclosure includes a kit case, a filter unit that is provided inside the kit case and that receives heating water from an internal line, removes at least a part of ionic substances contained in the received heating water by electric force, and releases soft water containing a smaller amount of ionic substances than the heating water, in which the internal line is provided inside a boiler that provides heating by heating and circulating water and the internal line, together with a heating line that provides heating to an object to be heated, forms a circulation line through which the heating water circulates, a filter line that is provided inside the kit case and that connects the filter unit and a water inlet opening that is formed in the kit case and through which the heating water is supplied, a water outlet line that is provided inside the kit case and that connects the filter unit and a water outlet opening that is formed in the kit case and through which the soft water is delivered to the main line, and a controller that is provided inside the kit case and that controls the filter unit.

### Advantageous Effects

Accordingly, the ion removal kits may be installed even without replacement of entire piping or equipment, and thus soft water may be easily supplied to a consumption site not having a means for removing ionic substances.

Operations of the ion removal kits may be efficiently controlled based on a state of water flowing through the ion removal kits.

### DESCRIPTION OF DRAWINGS

FIG. 1 is a conceptual diagram conceptually illustrating an ion removal kit according to a first embodiment of the present disclosure.

FIG. 2 is a conceptual diagram conceptually illustrating flows of raw water and soft water when the raw water is softened through a filter unit of the ion removal kit of FIG. 1.

FIG. 3 is a conceptual diagram illustrating a principle by which ions are removed in a CDI method.

FIG. 4 is a conceptual diagram conceptually illustrating a flow of raw water when the filter unit of the ion removal kit of FIG. 1 is regenerated.

FIG. 5 is a conceptual diagram illustrating a principle by which electrodes are regenerated in a CDI method.

FIG. 6 is a conceptual diagram conceptually illustrating an ion removal kit according to a second embodiment of the present disclosure.

FIG. 7 is a conceptual diagram conceptually illustrating an ion removal kit according to a third embodiment of the present disclosure.

FIG. 8 is a conceptual diagram conceptually illustrating another exemplary ion removal kit of the present disclosure.

FIG. 9 is a conceptual diagram conceptually illustrating another exemplary ion removal kit of the present disclosure.

FIG. 10 is a conceptual diagram conceptually illustrating a water-heating device using an ion removal kit according to an embodiment of the present disclosure.

FIG. 11 is a conceptual diagram conceptually illustrating a commercial boiler system using an ion removal kit according to an embodiment of the present disclosure.

FIG. 12 is a conceptual diagram conceptually illustrating a boiler having an ion removal kit embedded therein according to an embodiment of the present disclosure.

FIGS. 13 and 14 are conceptual diagrams illustrating installation processes of connecting an ion removal kit to a main line according to embodiments of the present disclosure.

### MODE FOR INVENTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. When a component is described as “connected”, “coupled”, or “linked” to another component, this may mean the components are not only directly “connected”, “coupled”, or “linked” but also are indirectly “connected”, “coupled”, or “linked” via a third component.

This application claims the benefit of priority to Korean Patent Application No. 10-2018-0143475, filed in the Korean Intellectual Property Office on Nov. 20, 2018, the entire contents of which are incorporated herein by reference.

### First Embodiment

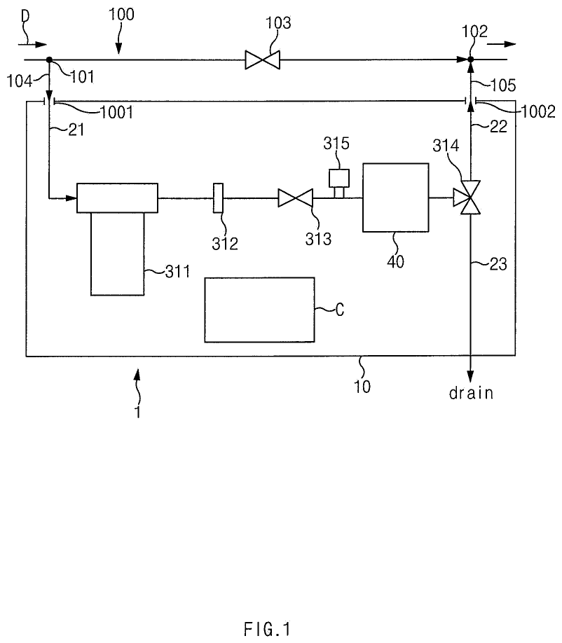

FIG. 1 is a conceptual diagram conceptually illustrating an ion removal kit 1 according to a first embodiment of the present disclosure. Referring to FIG. 1, the ion removal kit 1 according to the first embodiment of the present disclosure includes a kit case 10, a filter unit 40, a filter line 21, a water outlet line 22, and a controller C. The ion removal kit 1 is connected to a main line 100.

Main Line 100

The main line 100 is a line for supplying raw water to a consumption site. Accordingly, the main line 100 may be formed by a pipe through which water flows. The raw water may flow along the main line 100. Likewise, soft water provided by softening the raw water by the filter unit 40 that will be described below may flow along the main line 100.

In the main line 100, the water flows along one direction. The consumption site is connected to the most downstream location with respect to a flow direction D of the water in the main line 100, and the raw water or the soft water is delivered to the consumption site. That is, the main line 100 and the ion removal kit 1 are provided upstream of an inlet of the consumption site.

The consumption site to which the main line 100 connected to the ion removal kit 1 of the present disclosure delivers the water may be a faucet or a showerhead that adjusts release of the water to the outside. However, the type of the consumption site is not limited thereto, and any place to which the soft water, the raw water mixed with the soft water, or the raw water has to be supplied may be the consumption site.

The ion removal kit 1 according to the first embodiment of the present disclosure may be connected to one point on the main line 100, and the raw water flowing along the main line 100 may be supplied to the ion removal kit 1. In contrast, the soft water generated in the ion removal kit 1 may be supplied to the main line 100 through the one point. However, as illustrated in FIG. 1, the ion removal kit 1 may be connected to another point located downstream of the one point with respect to the flow direction D of the water. The raw water may be supplied from the main line 100 to the ion removal kit 1 through the one point, and the soft water generated in the ion removal kit 1 may be supplied from the ion removal kit 3 to the main line 100 through the other point.

A main valve 103 for interrupting the flow of the raw water flowing through the main line 100 or adjusting the flow rate of the raw water may be additionally disposed in-line with the main line 100.

Kit Case 10

The kit case 10 is a component for receiving the filter unit 40, the filter line 21, the water outlet line 22, the controller C, and other components that will be described below. The kit case 10 may be generally formed in a hollow rectangular parallelepiped shape. However, the shape of the kit case 10 is not limited thereto. A water-heating device case 12 and a boiler case 13 that will be described below are basically similar to, or the same as, the kit case 10.

The kit case 10 includes a water inlet opening 1001 and a water outlet opening 1002. The water inlet opening 1001 is an opening for receiving the raw water from the main line 100. The water outlet opening 1002 is an opening for delivering, to the main line 100, water including the soft water generated by the filter unit 40. Accordingly, water including the raw water or the soft water flows through the water inlet opening 1001 and the water outlet opening 1002.

The ion removal kit 1 of the present disclosure may further include connecting pipes 104 and 105. The connecting pipes 104 and 105 are components that connect the water inlet opening 1001 and the water outlet opening 1002 of the kit case 10 with the main line 100. Accordingly, the connecting pipes 104 and 105 may include the water inlet connecting pipe 104 and the water outlet connecting pipe 105 that are connected to the water inlet opening 1001 and the water outlet opening 1002, respectively.

The water inlet opening 1001 and the water outlet opening 1002 may be removably connected to one end of the connecting pipe 104 and one end of the connecting pipe 105, respectively. An opposite end of the connecting pipe 104 and an opposite end of the connecting pipe 105 are connected to the main line 100. However, the one end of the connecting pipe 104 and the one end of the connecting pipe 105 may extend from the water inlet opening 1001 and the water outlet opening 1002 and may be integrally formed with the kit case 10 or may be coupled to the kit case 10 so as not to be easily separated, and the opposite end of the connecting pipe 104 and the opposite end of the connecting pipe 105 may be removably coupled to the main line 100.

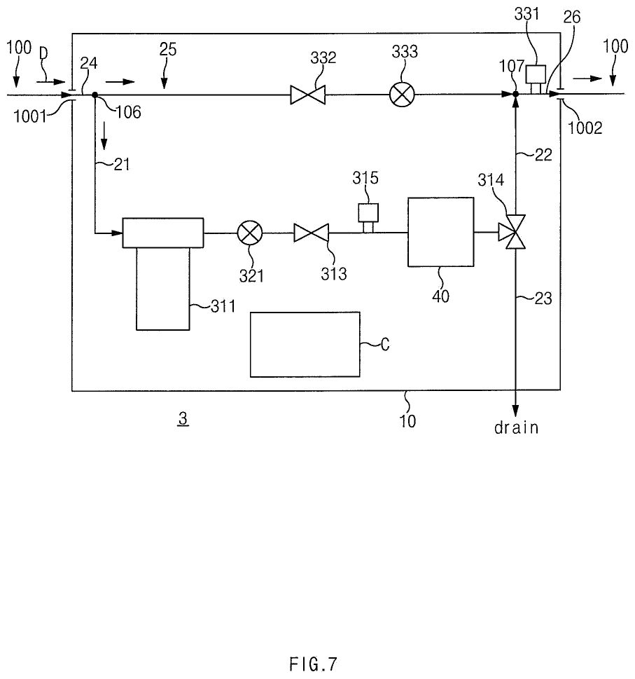

The water inlet opening 1001 and the water outlet opening 1002 may be connected with each other inside the kit case 10 through the filter line 21, the filter unit 40, and the water outlet line 22. Alternatively, the water inlet opening 1001 and the water outlet opening 1002 may be directly connected through a bypass line 25 of FIG. 7 that will be described below in a third embodiment. Accordingly, the raw water introduced into the ion removal kit 1 through the water inlet opening 1001 passes through flow passages and the filter unit 40 and is released through the water outlet opening 1002.

The kit case 10 may further include a drain hole through which a drain line 23 passes, in addition to the water inlet opening 1001 and the water outlet opening 1002. Waste water used to regenerate the filter unit 40 may be drained through the drain hole.

Filter Unit 40

The filter unit 40 is a component that removes at least a part of ionic substances contained in the raw water. The filter unit 40 is provided inside the kit case 10. The filter unit 40 receives the raw water from the main line 100 for supplying the raw water to the consumption site and removes at least a part of ionic substances contained in the received raw water by electro-deionization. Accordingly, water released from the filter unit 40 is soft water containing a smaller amount of ionic substances than the raw water.

More specifically, there is an electro-deionization method among methods of removing ionic substances. When DC voltage is applied to charged particles in an electrolyte, positively charged particles move to a negative electrode, and negatively charged particles move to a positive electrode. This is called electrophoresis. The electro-deionization method refers to a method of removing ions (ionic substances) in water by selectively adsorbing or moving the ions (the ionic substances) through electrodes or an ion exchange membrane, based on the principle of electric force (electrophoresis).

The electro-deionization method includes Electrodialysis (ED), Electro Deionization (EDI), Continuous Electro Deionization (CEDI), Capacitive Deionization (CDI), or the like. The filter unit 40 of an ED type includes electrodes and an ion exchange membrane. The filter unit 40 of an EDI type includes electrodes, an ion exchange membrane, and an ion exchange resin. In contrast, the filter unit 40 of a CDI type includes neither an ion exchange membrane nor an ion exchange resin, or does not include an ion exchange resin.

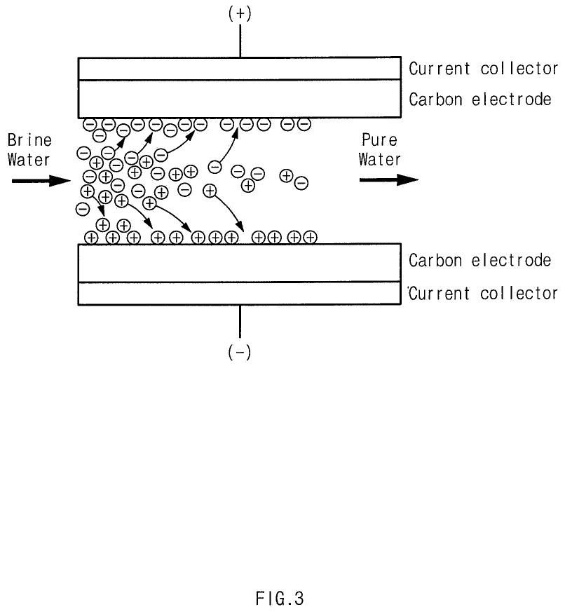

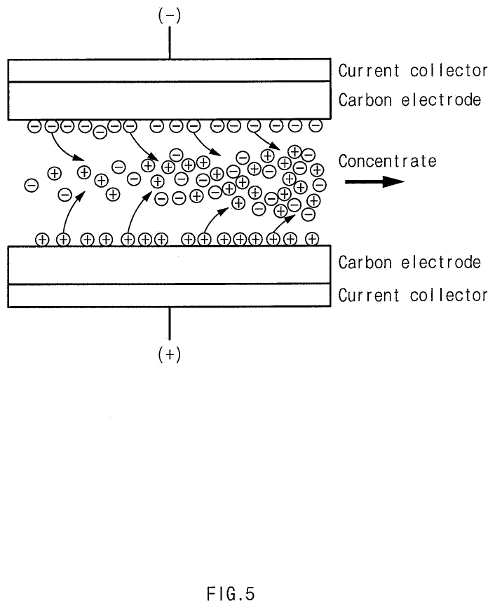

The filter unit 40 according to an embodiment of the present disclosure may remove ionic substances using a capacitive deionization (CDI) method among the electro-deionization methods. The CDI method refers to a method of removing ions using a principle by which ions (or ionic substances) are adsorbed on or desorbed from surfaces of electrodes by electric force. A specific principle by which the filter unit 40 removes ionic substances from the raw water, or is regenerated, by using the CDI method will be described below with reference to FIGS. 3 and 5.

The controller C, which will be described below, determines how to operate the filter unit 40. Accordingly, the filter unit 40 may be connected with the controller C through a conductive signal line to receive a control signal that is an electrical signal transmitted by the controller C and to operate according to the control signal. Furthermore, the controller C may be installed on the same circuit board as the filter unit 40 and may transfer a control signal to the filter unit 40 through the circuit board.

Filter Line 21

The filter line 21 is a component that delivers the raw water supplied from the main line 100 to the filter unit 40. Accordingly, the water inlet opening 1001 is connected to one end of the filter line 21, and the filter unit 40 is connected to an opposite end of the filter line 21. Because the filter line 21 connects the filter unit 40 inside the kit case 10 and the water inlet opening 1001, the filter line 21 is provided inside the kit case 10.

A pressure acquisition device 312 may be disposed in-line with the filter line 21 of the ion removal kit 1 according to the first embodiment of the present disclosure. The pressure acquisition device 312 is a component that obtains internal pressure of the filter line 21 to recognize the pressure of the raw water flowing through the filter line 21. Here, a method by which the pressure acquisition device 312 obtains the internal pressure includes a method of directly measuring the pressure in the filter line 21 using a pressure sensor and a method of measuring a value rather than pressure and calculating the pressure in the filter line 21 from the measured value. The pressure acquisition device 312 may be electrically connected to the controller C and may transfer, to the controller C, an electrical signal corresponding to the internal pressure value obtained by the pressure acquisition device 312.

Furthermore, a constant flow rate valve 313 may be disposed in the ion removal kit 1. The constant flow rate valve 313 is a valve that adjusts the flow rate and the pressure of the raw water flowing through the filter line 21 by adjusting the degree to which the filter line 21 is open.

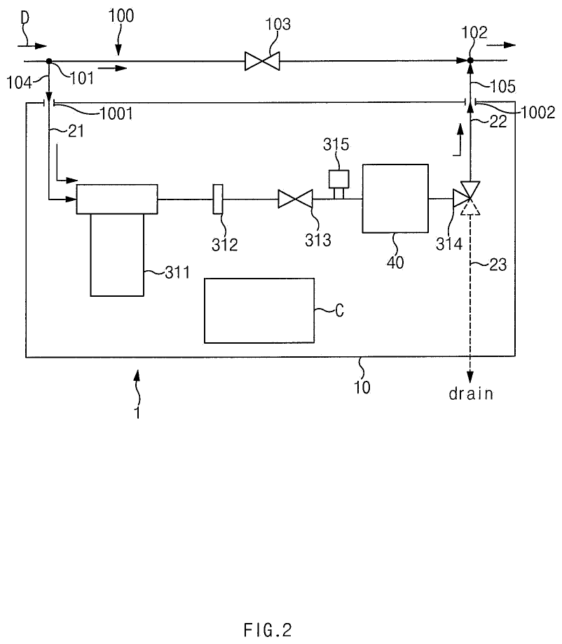

The constant flow rate valve 313 may be electrically connected to the controller C, and a control signal generated by the controller C may be transferred to the constant flow rate valve 313. A specific control method will be described below with reference to FIG. 2.

Furthermore, a front TDS sensor 315 may be disposed in the ion removal kit 1. The front TDS sensor 315 is a sensor that obtains total dissolved solids (TDS) contained in the raw water delivered to the filter unit 40 through the filter line 21. It may be difficult to directly obtain the amount of ionic substances contained in water, that is, to directly measure the hardness of water. When TDS of water is high, it may mean that the water contains a large amount of ionic substances. That is, the amount of ionic substances contained in the water may be estimated based on the TDS of the water. A specific control method will be described below with reference to FIG. 2.

Water Outlet Line 22

The water outlet line 22 is a component that delivers, from the filter unit 40 to the main line 100, soft water generated by removing at least a part of ionic substances from the raw water by the filter unit 40. Accordingly, the water outlet opening 1002 is connected to one end of the water outlet line 22, and the filter unit 40 is connected to an opposite end of the water outlet line 22. Because the water outlet line 22 connects the filter unit 40 inside the kit case 10 and the water outlet opening 1002, the water outlet line 22 is provided inside the kit case 10.

The drain line 23 may be additionally connected to the water outlet line 22, and a water outlet valve 314 may connect the drain line 23 and the water outlet line 22. Waste water used to regenerate the filter unit 40 may be drained through the drain line 23. The water outlet valve 314 may be implemented with a three-way valve capable of controlling fluid flows in three lines. Accordingly, the water outlet valve 314 may allow water released from the filter line 21 to be released to the main line 100 along the water outlet line 22, or may allow water released from the filter line 21 to be drained to the outside along the drain line 23. The control of the water outlet valve 314 may be performed by the controller C. Accordingly, the water outlet valve 314 may also be electrically connected with the controller C, and opening/shutting of the water outlet valve 314 may be electrically determined.

Controller C

The controller C is a component that is provided inside the kit case 10 and that controls the filter unit 40 and other components constituting the ion removal kit 1. Accordingly, the controller C may be electrically connected with the components constituting the ion removal kit 1 and may transmit or receive electrical signals with the components.

Because the controller C has to perform operations from values obtained from various types of sensors and generate and transfer control signals to the components, the controller C includes at least one processor capable of performing logic operations. A microprocessor such as a field programmable gate array (FPGA), an application specific integrated circuit (ASIC), or a central processing unit (CPU) may be used as the processor of the controller C. However, the type of the processor is not limited thereto.

Furthermore, the controller C includes a memory that stores a plurality of control instructions, on the basis of which the processor generates instructions for controlling the components. The processor may be programmed to receive the control instructions from the memory and generate electrical signals for controlling the components, based on the received control instructions. The memory may be a data store such as a hard disk drive (HDD), a solid state drive (SSD), a volatile medium, a non-volatile medium, or the like. However, the type of the memory is not limited thereto.

As illustrated, the controller C may be formed separately from the filter unit 40. However, the controller C may be integrally formed with the filter unit 40 and may be installed on the same circuit board as the filter unit 40.

The controller C may control the filter unit 40, based on a state of the raw water introduced through the water inlet opening 1001 or a state of water that is to be released through the water outlet opening 1002. In the first embodiment of the present disclosure, the controller C controls operation of the filter unit 40, based on contents determined from the internal pressure value of the filter line 21 obtained by the pressure acquisition device 312 disposed in-line with the filter line 21.

Based on TDS obtained by a TDS sensor that obtains at least one of TDS of the raw water supplied to the filter unit 40 or TDS of water released through the water outlet opening 1002, the controller C may control the filter unit 40 such that the TDS of the water released through the water outlet opening 1002 is equal to or less than reference rear TDS. Here, the TDS sensor includes the front TDS sensor 315 of FIG. 1 and a rear TDS sensor 331 that will be described in description of the third embodiment of FIG. 7.

The ion removal kit 1 may include a display (not illustrated) that displays predetermined information. The display may include a display device electrically connected with the controller C and may display TDS obtained by the front TDS sensor 315 such that a user is able to identify the TDS.

The ion removal kit 1 may include an input device (not illustrated). The input device may include an input device, such as a dial, which is electrically connected with the controller C. The input device may receive an input of execution time from the user and may transfer the execution time to the controller C. The execution time transferred to the controller C may be used as time during which the filter unit 40 performs a removal mode.

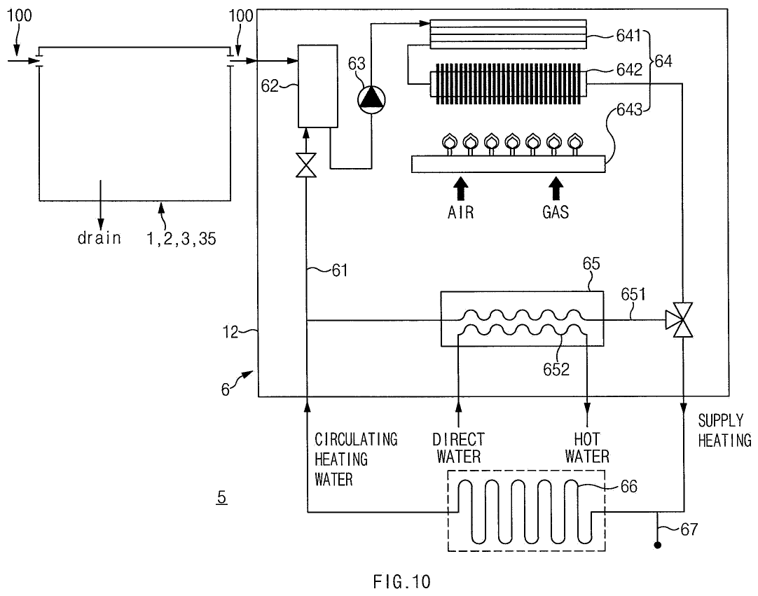

The ion removal kit 1 may include a communication module (not illustrated). The communication module may include a modem capable of communication with a water-heating device 6 of FIG. 10 that will be described below with reference to FIG. 10 and may receive an identifier from the water-heating device 6 of FIG. 10. The communication module may be a wireless modem capable of communication in a scheme such as WIFI. However, a communication scheme may be performed by using a sensor including an IR light-emitting part and an IR light-receiving part, and the configuration is not limited thereto.

The communication module may be electrically connected with the controller C, and when the received identifier is an effective identifier, the communication module may supply power to the filter unit 40 to operate the filter unit 40. The identifier is used to verify that the water-heating device was sold by an authenticated salesman. The identifier is stored in a storage medium included in the water-heating device and is used for control of the filter unit 40 through the communication module. If the water-heating device is a water-heating device sold by the authenticated salesman and the identifier received by the communication module is an effective identifier, the filter unit 40 operates because the filter unit is connected to the correct water-heating device. If the water-heating device is not a water-heating device sold by the authenticated salesman and the identifier is not effective, the filter unit 400 does not operate.

Hereinafter, a flow of water when raw water is softened by using the filter unit 40 of the ion removal kit 1 will be described with reference to drawings.

FIG. 2 is a conceptual diagram conceptually illustrating flows of raw water and soft water when the raw water is softened through the filter unit 40 of the ion removal kit 1 of FIG. 1. FIG. 3 is a conceptual diagram illustrating a principle by which ionic substances are removed in a CDI method.

Referring to FIG. 2, the ion removal kit 1 according to the first embodiment of the present disclosure is connected to the main line 100 at a water inlet point 101 that is one point on the main line 100 and a water outlet point 102 that is another point on the main line 100 and that is located downstream of the one point with respect to the flow direction D. Accordingly, at least part of raw water is delivered from the water inlet point 101 to the filter line 21 of the ion removal kit 1 through the water inlet opening 1001 and the water inlet connecting pipe 104. Part of the raw water may be delivered to the filter line 21, and the remaining raw water may continue to flow along the main line 100. Alternatively, all of the raw water may be delivered to the filter line 21.

In other words, a first location and a second location exist on the main line 100. At the first location, the main line 100 is directly or indirectly connected with the filter line 21, and at the second location, the main line 100 is directly or indirectly connected with the water outlet line 22. That is, the second location may be located downstream of the first location with respect to the flow direction of the raw water and may be the water outlet point 102, and the first location may be the water inlet point 101.

The raw water delivered to the filter line 21 may pass through a pre-treatment filter 311. The pre-treatment filter 311 is a component disposed in-line with the filter line 21 and is a filter that performs water purification other than removal of ions before the raw water is softened by electro-deionization. Accordingly, an activated carbon filter capable of removing fine impurities and residual chlorine (Cl₂) may be used as the pre-treatment filter 311. However, the type of the pre-treatment filter 311 is not limited thereto.

The raw water purified through the pre-treatment filter 311 flows along the filter line 21 and reaches the filter unit 40. At this time, the raw water may flow through the pressure acquisition device 312 and the constant flow rate valve 313 that are located upstream of the filter unit 40. The pressure acquisition device 312 obtains the internal pressure in the filter line 21 and transfers the obtained internal pressure to the controller C.

At least a part of ionic substances contained in the raw water delivered to the filter unit 40 are removed by the filter unit 40. As illustrated in FIG. 3, when water containing ions passes between electrodes in a state in which voltage is applied to the electrodes, negative ions move to a positive electrode, and positive ions move to a negative electrode. That is, adsorption occurs. The ions in the water may be removed by the adsorption. A mode in which the filter unit 40 removes, through electrodes, ions (ionic substances) in water passing through the filter unit 40 as described above is referred to as a removal mode.

The controller C may receive an obtained pressure value from the pressure acquisition device 312 and may control the filter unit 40, based on the pressure value. Specifically, when the internal pressure of the filter line 21 obtained by the pressure acquisition device 312 is lower than a first pressure that is a predetermined pressure, the controller C may operate such that power is applied to the filter unit 40 and the removal mode is performed by the filter unit 40.

Here, the first pressure may be equal to the internal pressure of the filter line 21 when the supply of the raw water to the consumption site is interrupted. When water is not used in the consumption site, the pressure at which the raw water is supplied from a water source exists, but water is not released because the consumption site is blocked. Therefore, the state of the first pressure that is the predetermined pressure is maintained in the main line 100 and the filter line 21. When water starts to be released and used in the consumption site in this situation, water starts to flow, and therefore the internal pressures of the main line 100 and the filter line 21 become lower than the first pressure. The controller C applies power to the filter unit 40 when the internal pressure of the filter line 21 is lower than the first pressure, such that the filter unit 40 is operated in the removal mode when water is used in the consumption site.

Furthermore, the controller C may control the constant flow rate valve 313 to adjust the pressure and the flow rate in the filter line 21. The controller C may control the constant flow rate valve 313 to adjust the opening degree of the filter line 21 such that the flow rate of the raw water flowing through the filter line 21 is maintained at a first flow rate that is a predetermined flow rate. Furthermore, the constant flow rate valve 313 may be controlled such that the internal pressure of the filter line 21 is maintained below a second pressure that is a predetermined pressure. As the flow rate of the raw water flowing through the filter line 21 remains constant, TDS of water that is to be released through the water outlet opening 1002 may be made below the reference rear TDS only by controlling the time during which the filter unit 40 performs the removal mode.

Based on TDS obtained by the front TDS sensor 315, the controller C may control the time during which the filter unit 40 performs the removal mode, such that TDS of water containing soft water that is to be released through the water outlet opening 1002 is equal to or less than the predetermined reference rear TDS. The reference rear TDS may be determined to be a TDS value suitable to be supplied to the consumption site.

Specifically, with an increase in TDS obtained by the front TDS sensor 315, the controller C may reduce the time during which the filter unit 40 performs the removal mode. When electro-deionization is used, there is a limitation in the amount of ionic substances that the electrodes are able to remove. Therefore, when raw water having high TDS is supplied to the filter unit 40, the electrodes may be more rapidly saturated, as compared with when raw water having a relatively low TDS value is supplied to the filter unit 40. Accordingly, by reducing the time during which the removal mode is performed and immediately performing a regeneration mode for regenerating the electrodes, a situation in which the raw water is released to the main line 100 through the water outlet line 22 in a state in which ionic substances are not removed even in the removal mode may be prevented, and the filter unit 40 may produce soft water having the target reference rear TDS.

The controller C may maintain the time during which the regeneration mode is performed, even though reducing the time during which the removal mode is performed, based on the TDS value obtained by the front TDS sensor 315. However, when reducing the time during which the removal mode is performed, the controller C may reduce the time during which the regeneration mode is performed. When reducing the time during which the regeneration mode is performed, the controller C applies higher voltage to the filter unit 40 to operate the filter unit 40 than when not reducing the time during which the regeneration mode is performed. As high voltage is applied to the filter unit 40, the electrodes may be regenerated more for the same time period. Accordingly, the controller C may reduce the operating period of the filter unit 40 that is the sum of the time during which the removal mode is performed and the time during which the regeneration mode is performed. Detailed description of the regeneration mode will be given below in description of FIG. 5.

The soft water generated by the filter unit 40 is released to the water outlet line 22. The water outlet valve 314, which is disposed in-line with the water outlet line 22, is opened and closed such that the soft water released from the filter unit 40 does not flow to the drain line 23, and the soft water is delivered to the water outlet opening 1002 through the water outlet line 22. The soft water is released to the water outlet point 102 through the water outlet connecting pipe 105 connected to the water outlet opening 1002. Accordingly, the soft water and the raw water may meet and mix with each other at the water outlet point 102 to make mixed water, and the mixed water may be delivered to the consumption site. However, if the main valve 103 is closed, only the soft water may be delivered to the consumption site, and if the filter unit 40 is not in the removal mode and the main valve 103 is open, only the raw water may be delivered to the consumption site through the main line 100.

Hereinafter, a flow of water when the electrodes of the filter unit 40 of the ion removal kit 1 are regenerated will be described with reference to drawings.

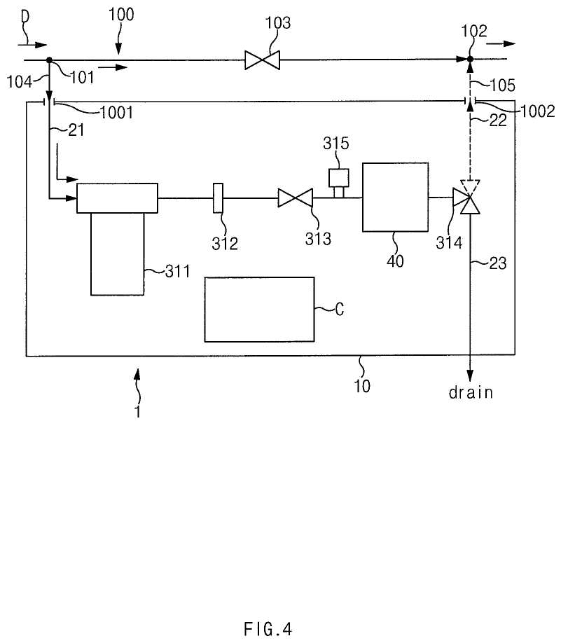

FIG. 4 is a conceptual diagram conceptually illustrating a flow of raw water when the filter unit 40 of the ion removal kit 1 of FIG. 1 is regenerated. FIG. 5 is a conceptual diagram illustrating a principle by which the electrodes are regenerated in a CDI method.

Referring to the drawings, even when the filter unit 40 is regenerated, raw water is delivered from the main line 100 to the filter line 21, similarly to when soft water is generated by using the filter unit 40. Accordingly, the foregoing description set forth in conjunction with FIG. 2 may be identically applied to a process in which the raw water is delivered to the filter unit 40.

The adsorption capacity of the electrodes included in the filter unit 40 is restrictive. Accordingly, when adsorption continues, the electrodes reach a state in which the electrodes can no longer adsorb ions. To prevent this, the electrodes need to be regenerated by detaching ions adsorbed on the electrodes. To this end, as illustrated in FIG. 5, voltage opposite to that in the removal mode may be applied to the electrodes, or no voltage may be applied to the electrodes. A mode in which the filter unit 40 regenerates the electrodes in this way is referred to as a regeneration mode. The regeneration mode may be performed before or after the removal mode so that the regeneration mode and the removal mode may be alternately performed. The time during which the regeneration mode and the removal mode are performed may be variously set.

Because the filter unit 40 is in the regeneration mode, the raw water delivered to the filter unit 40 is not softened by the filter unit 40, but is used to regenerate the electrodes of the filter unit 40. Accordingly, the concentration of ionic substances in the raw water delivered to the filter unit 40 increases as the raw water passes through the filter unit 40 in the regeneration mode.

The water in which the concentration of ionic substances is increased is released to the water outlet line 22. In the regeneration mode, the water outlet valve 314 may be opened and closed to allow for a flow of water from the water outlet line 22 to the drain line 23 and interrupt a flow of water to the main line 100 through the water outlet line 22. Accordingly, the water in which the concentration of ionic substances is increased is drained to the outside through the drain line 23. Only the raw water may be supplied to the consumption site by the main line 100. At this time, all of water supplied from a water source is used only to regenerate the electrodes included in the filter unit 40, and therefore the raw water may not be supplied to the consumption site.

### Second Embodiment

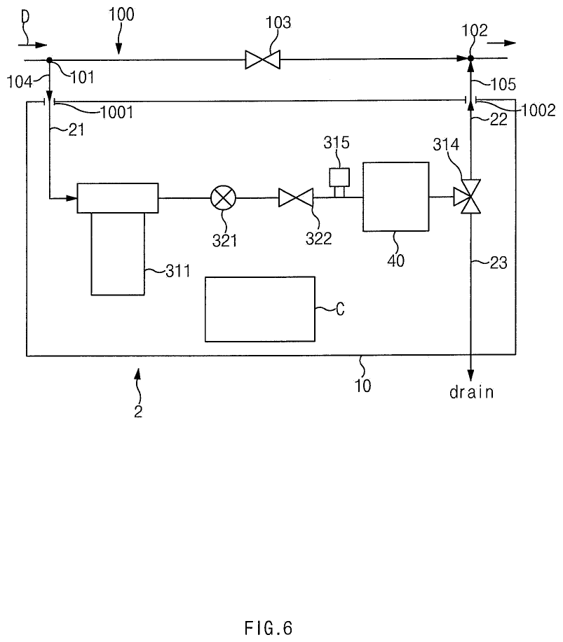

FIG. 6 is a conceptual diagram conceptually illustrating an ion removal kit 2 according to a second embodiment of the present disclosure. Referring to FIG. 6, a filter flow rate acquisition device 321 may be disposed in-line with a filter line 21 of the ion removal kit 2 according to the second embodiment of the present disclosure. The ion removal kit 2 of the second embodiment is very similar to the ion removal kit 1 of the first embodiment. Therefore, only a difference therebetween will be described below, and the foregoing descriptions of the first embodiment may be identically applied to the remaining redundant components.

The filter flow rate acquisition device 321 is a component that obtains the flow rate of raw water flowing through the filter line 21. Here, a method of obtaining the flow rate of the raw water by the filter flow rate acquisition device 321 includes a method of directly measuring the flow rate of the raw water flowing in the filter line 21 by using a flow rate sensor and a method of measuring a value rather than a flow rate and calculating the flow rate of the raw water flowing in the filter line 21 from the measured value.

A controller C may receive the obtained flow rate value from the filter flow rate acquisition device 321 and may control a filter unit 40, based on the flow rate value. Specifically, when the flow rate of the raw water in the filter line 21 that is obtained by the filter flow rate acquisition device 321 is greater than 0, the controller C may operate such that power is applied to the filter unit 40 and a removal mode is performed by the filter unit 40.

The reason why the controller C operates when the flow rate is greater than 0 is because a situation in which the raw water flows through the filter line 21 means that water starts to be used in a consumption site. When water is not used in the consumption site, flow rates in a main line 100 and the filter line 21 are equal to 0 because the consumption site is blocked and water is not released. When water starts to be released and used in the consumption site in this situation, water starts to flow, and therefore flow rates in the main line 100 and the filter line 21 are greater than 0. The controller C applies power to the filter unit 40 when the flow rates are greater than 0, such that the filter unit 40 is operated in the removal mode when water is used in the consumption site

A flow rate control valve 322 may be disposed in-line with the filter line 21 of the ion removal kit 2 according to a modified example of the second embodiment of the present disclosure. The flow rate control valve 322 is a valve that adjusts the pressure and the flow rate of the raw water flowing through the filter line 21 by adjusting the opening degree of the filter line 21. The flow rate control valve 322 may include a stepping motor that performs rotary motion to adjust the opening degree of the filter line 21.

If the flow rate control valve 322 is used together with the filter flow rate acquisition device 321, the controller C may adjust the flow rate of the raw water in the filter line 21, which is transferred from the filter flow rate acquisition device 321, using the flow rate control valve 322 so as to maintain the pressure of the raw water flowing through the filter line 21 below a second pressure that is a predetermined pressure.

The flow rate control valve 322 may be used together with a pressure-reducing valve (not illustrated), or may further include a function of reducing the pressure of the raw water. The pressure-reducing valve is a valve that decreases the pressure of the raw water to allow the flow rate control valve 322 to more smoothly adjust the flow rate. Based on TDS obtained by a front TDS sensor 315, the controller C may additionally adjust the flow rate of the raw water flowing along the filter line 21 by using a valve disposed in-line with the main line 100 and a valve disposed in-line with the filter line 21 such that TDS of water released through a water outlet opening 1002 is equal to reference rear TDS. Accordingly, the controller C is connected with the flow rate control valve 322 and adjusts the flow rate of the raw water by adjusting the opening degree of the filter line 21. At this time, the controller C may adjust the flow rate of the raw water flowing along the filter line 21 at the same time as controlling the time during which the filter unit 40 performs the removal mode.

Specifically, with an increase in TDS obtained by the front TDS sensor 315, the controller C may decrease the flow rate of the raw water flowing along the filter line 21. The filter unit 40 using a CDI method, as described above, has a limitation in the amount of ionic substances that can be treated in a state in which there is no regeneration. Accordingly, even though raw water having high TDS is introduced by reducing the flow rate provided to the filter unit 40, the filter unit 40 may remove ionic substances of a high percentage to produce and release soft water having target TDS. Thus, water having target reference rear TDS may be released through the water outlet opening 1002.

The capacity of water that the filter unit 40 can receive is constant, and the flow speed of the water is reduced as the flow rate of the water is decreased. When the percentage of ionic substances contained in the water and the magnitude of power supplied to the electrodes are equal, the time during which the water passes through the filter unit 40 increases with a decrease in the flow rate of the water, and thus a relatively large amount of ionic substances may be adsorbed on the electrodes. Accordingly, the removal ratio of ionic substances may be raised with a decrease in the flow rate of the water. Here, the removal ratio refers to the ratio of the amount of ionic substances removed in the filter unit 40 to the amount of ionic substances introduced into the filter unit 40. Accordingly, rear TDS may be adapted to the target reference rear TDS by decreasing the flow rate of the raw water flowing along the filter line 21 with an increase in TDS obtained by the front TDS sensor 315.

In addition, the controller C may adjust the amount of ionic substances removed in the filter unit 40 in the removal mode by adjusting the magnitude of power supplied to the electrodes. A force by which the electrodes adsorb ions becomes stronger with an increase in the magnitude of power supplied to the electrodes. Therefore, when the flow rate of water and the percentage of ionic substances contained in the water are equal, the electrodes to which higher power is supplied may adsorb more ions.

### Third Embodiment

FIG. 7 is a conceptual diagram conceptually illustrating an ion removal kit 3 according to a third embodiment of the present disclosure.

Referring to FIG. 7, the third embodiment of the present disclosure includes a bypass line 25. The remaining components of the ion removal kit 3 of the third embodiment other than the bypass line 25 are very similar to those of the ion removal kit 3 of the second embodiment. Therefore, only a difference therebetween will be described below, and the foregoing descriptions of the second embodiment may be identically applied to the remaining redundant components. However, the ion removal kit 3 according to the third embodiment may have a modified example including a pressure acquisition device 312 and a constant flow rate vale 313, similarly to that of the first embodiment.

The ion removal kit 3 according to the third embodiment of the present disclosure, in which the bypass line 25 is formed, may be connected with a main line 100 by dividing the main line 100 into portions as illustrated in FIG. 7, removably connecting a portion corresponding to an upstream side with respect to a flow direction D of water to a water inlet opening 1001, and removably connecting a portion corresponding to a downstream side to a water outlet opening 1002. However, the ion removal kit 3 may be connected to the water inlet point 101 and the water outlet point 102 of the existing main line 100 through the connecting pipes 104 and 105 as illustrated in FIG. 1.

The bypass line 25 is a component that is connected to the water inlet opening 1001 and the water outlet opening 1002 and that directly connects the two openings. The bypass line 25 is received inside a kit case 10. The bypass line 25 serves to selectively bypass, to the water outlet opening 1002, at least part of raw water that is supplied through the water inlet opening 1001 and that is to be supplied to a filter unit 40. This is because the water inlet opening 1001 and the water outlet opening 1002 are connected through a filter line 21, the filter unit 40, and a water outlet line 22 at the same time as being connected through the bypass line 25.

Part of the raw water supplied into the kit case 10 through the water inlet opening 1001 is introduced into the bypass line 25, and the rest is introduced into the filter line 21. The bypass line 25 and the filter line 21, as illustrated, may be indirectly connected with the water inlet opening 1001 through a first delivery line 24 connected to the water inlet opening 1001 and may be split at a branching point 106, and the raw water may be divided up between the bypass line 25 and the filter line 21. However, the bypass line 25 and the filter line 21 may be directly connected to the water inlet opening 1001 without the first delivery line 24, and the raw water may be divided up between the bypass line 25 and the filter line 21.

The raw water flows through the bypass line 25 and is delivered to the water outlet opening 1002, and an operation of changing the raw water into soft water is performed in the filter line 21 as described in the descriptions of the first embodiment and the second embodiment. The bypass line 25 and the water outlet line 22 may join together at a confluence point 107, may be indirectly connected with the water outlet opening 1002 through a second delivery line 26 connected with the water outlet opening 1002, and may release the raw water and the soft water through the water outlet opening 1002. However, the bypass line 25 and the water outlet line 22 may be directly connected to the water outlet opening 1002 without the second delivery line 26.

A bypass valve 332 may be disposed in-line with the bypass line 25. The bypass valve 332 is a valve that adjusts the opening degree of the bypass line 25 to adjust the flow rate of the raw water bypassed through the bypass line 25. A controller C may be electrically connected with the bypass valve 332 and may adjust the flow rate of the raw water bypassed through the bypass line 25.

The controller C may adjust the flow rate of the bypassed raw water using the bypass valve 332 and the filter flow rate acquisition device 321, which has been described in the description of the second embodiment, such that TDS of water released through the water outlet opening 1002 is equal to or less than reference rear TDS. TDS of the soft water generated by the filter unit 40 is generally significantly lower than the reference rear TDS that is reference TDS suitable to be used in a consumption site. Therefore, mixed water formed by mixing the soft water and the raw water may be released through the water outlet opening 1002 and may be supplied to the consumption site. Thus, water having TDS suitable to be used may be supplied to the consumption site at the same time that a sufficient amount of water is supplied to the consumption site.

When f denotes the flow rate of the raw water flowing through the filter line 21 that is obtained by the filter flow rate acquisition device 321, Feed TDS denotes TDS of the raw water supplied, Target TDS denotes target reference rear TDS, CDI TDS denotes TDS of the soft water generated in the filter unit 40, and RR (recovery rate) denotes the ratio of the amount of the soft water generated in the filter unit 40 to the total amount of soft water introduced into the filter unit 40, the flow rate x of the raw water bypassed through the bypass line 25 may be determined by Equation below.

$$x ( L / min ) = \frac{f \times R R \times ( Target TDS - CDI TDS )}{Feed TDS - Target TDS} \qquad [ Equation 1 ]$$

Here, the unit of Target TDS, Feed TDS, and CDI TDS is ppm, and the unit of f is L/min that is the same as that of x.

Target TDS may be arbitrarily determined, or a reference value may be given. f may be obtained through the filter flow rate acquisition device 321. RR may be determined depending on how to control the filter unit 40, or may be given in the manufacture. Feed TDS may be given because Feed TDS is TDS of the raw water, or may be obtained by using a front TDS sensor 315. CDI TDS may be given in the manufacture, or may be obtained by a CDI TDS sensor (not illustrated) that may be additionally disposed behind the filter unit 40.

A bypass flow rate acquisition device 333 may be disposed in-line with the bypass line 25 of the ion removal kit 3 according to a modified example of the third embodiment of the present disclosure. The bypass flow rate acquisition device 333 is a component that obtains the flow rate of the raw water bypassed through the bypass line 25. Here, a method of obtaining the flow rate of the raw water by the bypass flow rate acquisition device 333 includes a method of directly measuring the flow rate of the raw water flowing in the bypass line 25 by a flow rate sensor and a method of measuring a value rather than a flow rate and calculating the flow rate of the raw water flowing in the bypass line 25 from the measured value. Whether water having a desired level of TDS is released through the water outlet opening 1002 may be determined by using the bypass flow rate acquisition device 333. That is, when the controller C adjusts the bypassed flow rate using the bypass valve 332, whether the flow rate is controlled to be the same as x in Equation 1 may be determined based on a flow rate value obtained by the bypass flow rate acquisition device 333.

The ion removal kit 3 according to another modified example of the third embodiment may include a rear TDS sensor 331. The rear TDS sensor 331 is a sensor that obtains TDS of water released through the water outlet opening 1002. Accordingly, the rear TDS sensor 331 may be disposed in-line with the second delivery line 26. However, the position in which the rear TDS sensor 331 is disposed is not limited thereto.

Even without exactly knowing the flow rate of the raw water bypassed through the bypass line 25, the controller C may perform control using the rear TDS sensor 331 such that TDS of water obtained by the rear TDS sensor 331 is equal to or less than the reference rear TDS. When the flow rate of the raw water bypassed is increased, TDS of water released through the water outlet opening 1002, which is water of which the TDS is obtained by the rear TDS sensor 331, may be increased. In contrast, when the flow rate of the raw water bypassed is decreased, the reverse will happen.

Specifically, y that is TDS of water to be released through the water outlet opening 1002 is determined by Equation 2 below. Accordingly, when the bypassed flow rate x is increased, y that is TDS of water to be released through the water outlet opening 1002 is decreased.

$$y ( mg / L ) = \frac{Feed TDS \times x + CDI TDS \times f}{x + f} \qquad [ Equation 2 ]$$

The remaining variables other than x in Equation 2 may be given or may be obtained through sensors, and y may be changed by adjusting x using the bypass valve 332. The y value may be consistently identified by using the rear TDS sensor 331.

The controller C may perform control such that only the soft water is supplied through the main line 100, by interrupting the bypass line 25 by closing the bypass valve 332. When the performance of the filter unit 40 is not sufficient for the generated soft water to satisfy the reference rear TDS, the controller C may control the bypass valve 332 in this way.

Another Exemplary Ion Removal Kit 35

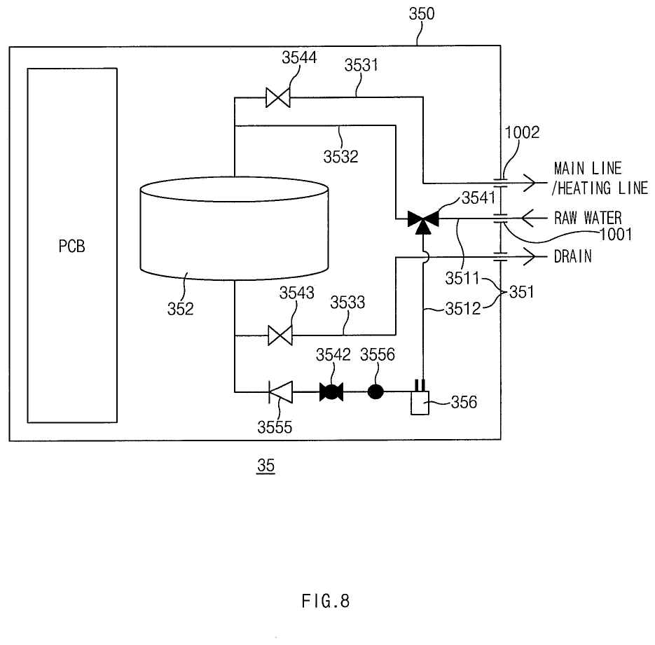

FIG. 8 is a conceptual diagram conceptually illustrating another exemplary ion removal kit 35 of the present disclosure. The ion removal kit 35 has a basic feature in that the ion removal kit 35 is not provided inside a boiler, but is portable independently of a water-heating device such as a boiler or a water heater.

The exemplary ion removal kit 35, as illustrated in FIG. 8, includes a filter unit 352, a case 350, first to fourth lines 351, 3531, 3532, and 3533, and a three-way valve 3541.

The filter unit 352 removes, by electro-deionization, ionic substances in water to be supplied to a main line or a circulation line of a water-heating device for providing heating or hot water, but is provided independently of the water-heating device. The filter unit 352 may include a separate PCB inside the case 350 for independent control. The case 350 receives the filter unit 352 therein and is provided to be portable.

The first line 351 is a line for supplying water (raw water) to an inlet of the filter unit 352 and is directly or indirectly connected to a water source such as a faucet. The first line 351 includes a portion 3511 from a portion connected to the water source through a water inlet opening 1001 to the three-way valve 3541 and a portion 3512 from the three-way valve 3541 to the filter unit 352.

The second line 3531 is a line for directly or indirectly connecting an outlet of the filter unit 352 and the main line or the circulation line. Accordingly, the second line 3531 is connected with a water outlet opening 1002.

The third line 3532 is a line for connecting the first line 351 and the outlet of the filter unit 352, and the three-way valve 3541 is provided at the point where the first line 351 and the third line 3532 are connected. The raw water may be supplied to the inlet of the filter unit 352 or the outlet of the filter unit 352 depending on operation of the three-way valve 3541.

The fourth line 3533 is a line for connecting the inlet of the filter unit 352 with the outside of the case 350 and draining water together with desorbed ionic substances.

The filter unit 352 may selectively perform one of a removal mode for removing ionic substances in water through electrodes by a capacitive deionization method among electro-deionization methods and a regeneration mode for regenerating the electrodes before or after the removal mode as needed.

In the removal mode, water (raw water) supplied to the filter unit 352 through the first line 351 is supplied to the main line or a heating line through the second line 3531 after ionic substances are removed from the water. To this end, the three-way valve 3541 guides the raw water supplied from the water source toward the inlet of the filter unit 352, a valve 3544 disposed in-line with the second line 3531 opens the second line 3531, and a valve 3543 disposed in-line with the fourth line 3533 closes the fourth line 3533.

In the regeneration mode, the raw water supplied to the first line 351 from the water source is supplied to the filter unit 352 through the third line 3532 by the three-way valve 3541 and is drained outside the case 350 through the fourth line 3533. To this end, the three-way valve 3541 guides the raw water supplied from the water source toward the third line 3532, the valve 3544 disposed in-line with the second line 3531 closes the second line 3531, and the valve 3543 disposed in-line with the fourth line 3533 opens the fourth line 3533.

The exemplary ion removal kit 35 may be used for an existing water-heating device in which a device for removing ionic substances in water used for heating or hot water is not installed and may remove ionic substances in the raw water.

For example, to supply the raw water to a boiler for the first time or additionally supply the raw water to the boiler after the first supply of the raw water, the first line 351 may be connected to the water source through the water inlet opening 1001, and the second line 3531 may be connected to the water outlet opening 1002 connected with the above-described main line. When a raw water supply source starts to supply the raw water, water containing soft water from which ionic substances are removed by the filter unit 352 may be supplied to the boiler.

Meanwhile, the exemplary ion removal kit 35 may further include a controller (not illustrated) for controlling the above-described valves.

In addition to the control of the valves, the controller may estimate the amount of ionic substances in the raw water through a front TDS sensor 356 disposed in-line with the first line 351, may determine time to execute a regeneration mode based on the estimated amount, and may automatically operate the three-way valve 3541 to execute the regeneration mode when determining that it is time to execute the regeneration mode. Alternatively, when a previously input condition is achieved, the controller may automatically execute the regeneration mode.

The exemplary ion removal kit 35 may further include a pump (not illustrated) to forcibly feed water to the main line or the heating line or may control, through the controller, a pump (not illustrated) that is disposed in-line with the main line.

For reference, in FIG. 8, reference numeral 3542 not described is a control valve that adjusts the amount of water supplied to the inlet of the filter unit 352, reference numeral 3556 not described is a sensor that senses the flow rate in the first line 3512, and reference numeral 3555 not described is a check valve for preventing a reverse flow of water.

Another Exemplary Ion Removal Kit 36

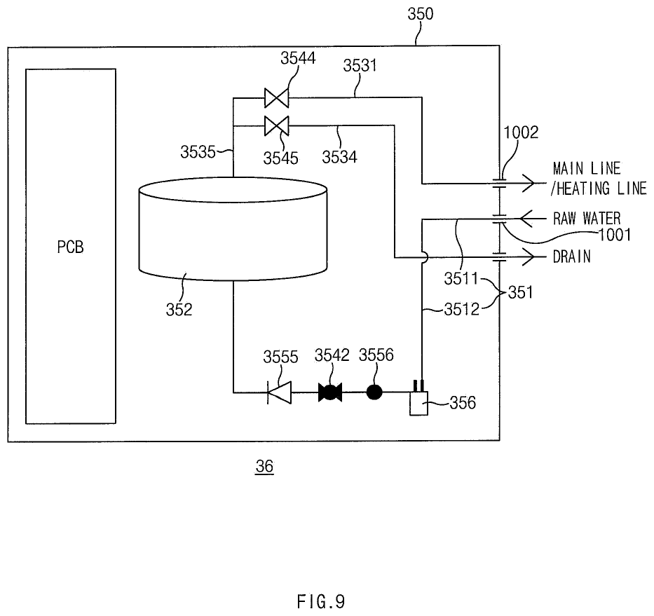

FIG. 9 is a conceptual diagram conceptually illustrating another exemplary ion removal kit 36 of the present disclosure. Referring to FIG. 9, it can be seen that the exemplary ion removal kit 36 is basically similar to the exemplary ion removal kit 35 of FIG. 8, but does not include the three-way valve 3541 of FIG. 8 and includes a first line 351 into which lines for supplying raw water are integrated. Furthermore, referring to FIG. 9, it can be seen that unlike in FIG. 8, a third line 3534 is not used as a line through which the raw water flows, but is used only as a line through which water discarded after regeneration of a filter unit 352 flows. That is, in the other exemplary ion removal kit 36, when the raw water is supplied to the filter unit 352 through the first line 351, the raw water is softened in a removal mode and released through a second line 3531 or is drained through the third line 3534 in a state of containing a large amount of ionic substances by regeneration of electrodes of the filter unit 352 in a regeneration mode. A direction in which the raw water is introduced into the filter unit 352 and a direction in which water is released from the filter unit 352 are fixed.

The ion removal kit 36 having the structure illustrated in FIG. 9 has an advantage in that the structure is relatively simplified. However, when water soiled by executing the regeneration mode is drained through the third line 3534 and then the ion removal kit 36 switches to the removal mode again, water softened by the filter unit 352 may be delivered to the second line 3531 in a state of further containing ionic substances. Water may be delivered from the filter unit 352 to the second line 3531 or the third line 3534 only through an intermediate line 3535 connected to a rear end portion of the filter unit 352. When the ion removal kit 36 switches to the removal mode and releases soft water from the filter unit 351 in a state in which water containing a large amount of ionic substances in the regeneration mode is released and left in the intermediate line 3535, the soft water is mixed with the water left in the intermediate line 3535, and therefore a situation in which ionic substances are added to the soft water occurs.

Accordingly, to avoid this situation, a valve 3545 disposed in-line with the third line 3534 and a valve 3544 disposed in-line with the second line 3531 may be controlled according to each mode. In the removal mode, the valve 3544 disposed in-line with the second line 3531 is opened, and the valve 3545 disposed in-line with the third line 3534 is closed. In the regeneration mode, the valve 3544 disposed in-line with the second line 3531 is closed, and the valve 3545 disposed in-line with the third line 3534 is opened. However, when the ion removal kit 36 switches from the regeneration mode to the removal mode, the same state as that in the regeneration mode, in which the valve 3544 disposed in-line with the second line 3531 is closed and the valve 3545 disposed in-line with the third line 3534 is opened, may be maintained for a predetermined period of time. Accordingly, water that contains a large amount of ionic substances and that is located in the intermediate line 3535 may be drained through the third line 3534 for the predetermined period of time by soft water released from the filter unit 352. After the predetermined period of time passes, the valve 3544 disposed in-line with the second line 3531 is opened, and the valve 3545 disposed in-line with the third line 3534 is closed. Accordingly, soft water not polluted by water left in the intermediate line 3535 may be released to a main line through the second line 3531.

Water-Heating Device 6

FIG. 10 is a conceptual diagram conceptually illustrating the water-heating device 6 using the ion removal kit 1, 2, 3, 35, or 36 according to an embodiment of the present disclosure. The water-heating device 6 refers to a device that receives and heats water to provide heating or hot water. The water-heating device 6 refers to a boiler for providing heating, a water heater for providing hot water (a water heater of a direct water type that does not include a separate hot-water tank or a water heater of a tank type that includes a separate hot-water tank), or a combined water heater and boiler. Referring to FIG. 10, the water-heating device 6 using the ion removal kit 3 according to an embodiment of the present disclosure includes an expansion tank 62, a heat exchange device 64, a heating device, a circulation line, and a water-heating device case 12 in which the aforementioned components are received. Accordingly, a water-heating device system 5 including the ion removal kit 1, 2, 3, 35, or 36 and the water-heating device 6 may be formed. Referring to the drawing, it can be seen that the ion removal kit 1, 2, 3, 35, or 36 is connected to the main line 100 and a consumption site of the main line 100 is the water-heating device 6.

The water-heating device 6 is a device that heats water and circulates or releases the heated water. Accordingly, the water-heating device 6 has the circulation line for circulating water, and the circulation line has an internal line 61 located inside the water-heating device case 12 and a heating line 66 that provides heating to an object to be heated. The internal line 61 and the heating line 66 are connected to form the entire circulation line. A drain hole 67 is formed in the circulation line to drain water. As heated water is supplied to a hot-water line 651 connected to the circulation line, the heated water may exchange heat with a direct-water pipe 652 in a hot-water heat exchanger 65 to heat direct water, and the direct water may be released as hot water. Furthermore, as heated water is supplied to the heating line 66, heating may be provided to a desired location.

The internal line 61 passes through the heat exchange device 64 such that the water-heating device 6 heats water. The heat exchange device 64 may include a heat source 643 that generates radiant heat and combustion gas by burning fuel and oxygen, a sensible heat exchanger 642 that transfers the radiant heat generated in the heat source 643 and sensible heat of the combustion gas to water flowing through the internal line 61, and a latent heat exchanger 641 that transfers the radiant heat generated in the heat source 643 and latent heat generated by a phase change of the combustion gas to the water flowing through the internal line 61. A boiler in which heat is double used in this way is usually referred to as a condensing boiler. However, the heat source 643 of the present disclosure is not limited to a condensing type including both the sensible heat exchanger 642 and the latent heat exchanger 641, and any burner or heat exchanger appropriate for heating water for providing heating or hot water may be applied to the heat source 643 of the present disclosure.

The expansion tank 62 may be disposed in-line with the circulation line and may receive volume expansion of water flowing along the circulation line. The expansion tank 62 is connected with the main line 100 and is replenished with water released by the ion removal kit 1, 2, 3, 35, or 36. The water released by the ion removal kit 1, 2, 3, 35, or 36 may be soft water or mixed water in which soft water and raw water are mixed, and thus unlike the case where raw water circulates, occurrence of scale may be prevented when the water circulates through the circulation line. The water circulating through the circulation line may be drained to the outside through the drain hole 67. When soft water continues to be produced through the ion removal kit 1, 2, 3, 35, or 36 and is introduced into the water-heating device 6 in a state in which the drain hole 67 is open, newly produced soft water is supplied to the circulation line, and the existing water circulating through the circulation line is drained through the drain hole 67. Accordingly, the water circulating through the circulation line may be replaced with water containing a smaller amount of ionic substances than before.

A circulation pump 63 may be disposed in-line with the circulation line and may circulate water in a predetermined direction.

Commercial Boiler System 7

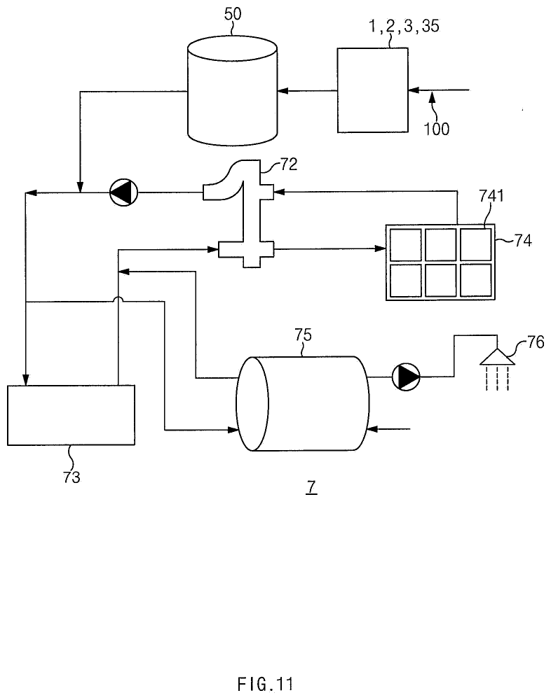

FIG. 11 is a conceptual diagram conceptually illustrating the commercial boiler system 7 using the ion removal kit 3 according to an embodiment of the present disclosure. Referring to FIG. 11, the boiler system 7 according to the embodiment of the present disclosure that uses the ion removal kit 1, 2, 3, 35, or 36 and that includes a supplementary tank 50 may include a heating device 74 and may further include a storage tank 75 and a circulation valve 72.

Referring to the drawing, it can be seen that the ion removal kit 1, 2, 3, 35, or 36 is connected to the main line 100 and a consumption site of the main line 100 is the heating device 74 of the boiler system 7. The ion removal kit 1, 2, 3, 35, or 36 may be fixed to the main line 100. The filter unit 40 of FIG. 1, 2, 4, 6, or 7 that the ion removal kit 1, 2, 3, 35, or 36 includes may operate when water is supplied to the supplementary tank 50 after the kit case 10 of FIG. 1, 2, 4, 6, or 7 is fixedly installed such that the filter line 21 of FIG. 1, 2, 4, 6, or 7 and the water outlet line 22 of FIG. 1, 2, 4, 6, or 7 are connected to the main line 100. Here, when the kit case is fixedly installed, it may mean that the kit case is not temporarily used, but is installed to be used without being separated from the main line 100 as in another embodiment even though water flowing in the boiler system 7 is completely replaced after the kit case is installed once. Accordingly, every time the supplementary tank 50 is replenished, the ion removal kit 1, 2, 3, 35, or 35 operates to produce soft water and releases water containing the soft water to the supplementary tank 50.

The boiler system 7 according to the embodiment of the present disclosure is a boiler system 7 that heats a large amount of water and supplies the heated water as hot water or that is provided in a position 73, such as a jjimjilbang, which requires heating. Accordingly, the boiler system 7 has the storage tank 75 capable of storing a large amount of heated water and releases the stored heated water to a shower 76 or delivers the stored heated water to the position 73, such as a jjimjilbang, which requires heating.

The circulation valve 72 is disposed in the boiler system 7. The circulation valve 72 controls a flow of water in pipes connecting the heating device 74 and a position to which heated water has to be supplied. The circulation valve 72 delivers low-temperature water to the heating device 74, and if the water temperature is below a predetermined temperature when the low-temperature water is heated and supplied to the circulation valve 72, the circulation valve 72 returns the water to the heating device 74 to additionally heat the water. If the water released from the heating device 74 has the predetermined temperature or more, the water is delivered to a jjimjilbang or the storage tank 75 for use.

The heating device 74 may be a heating device 74 of a cascade type that is formed by connecting a plurality of boiler units 741 in parallel. As the plurality of boiler units 741 are connected in parallel, it is easy to heat water to a desired temperature within given time even though a large amount of water is supplied to the boiler system 7.

The supplementary tank 50 that stores supplementary water to be supplied when water circulating in the boiler system 7 is insufficient is disposed. As the ion removal kit 1, 2, 3, 35, or 36 is connected to the supplementary tank 50, the ion removal kit 1, 2, 3, 35, or 36 allows the supplementary tank 50 to be consistently replenished with soft water.

Boiler 8

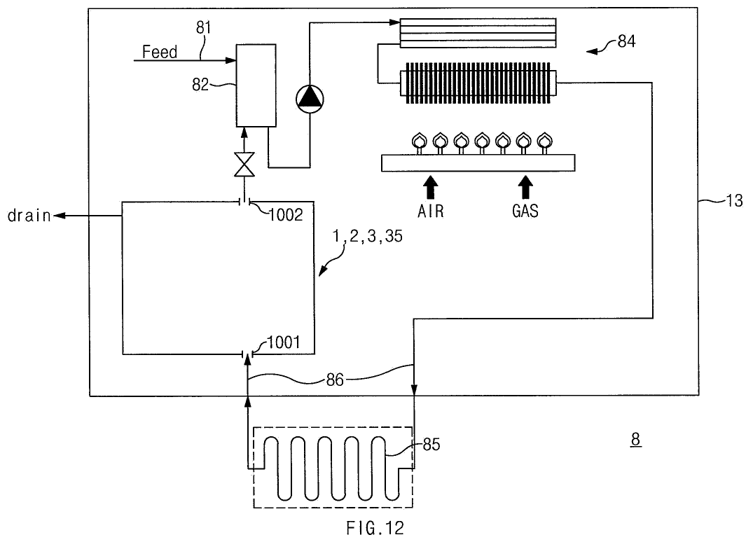

FIG. 12 is a conceptual diagram conceptually illustrating a boiler 8 having the ion removal kit 1, 2, 3, 35, or 36 embedded therein according to an embodiment of the present disclosure. Referring to FIG. 12, the boiler 8 having the ion removal kit 1, 2, 3, 35, or 36 embedded therein according to the embodiment of the present disclosure is a device that heats and circulates water to provide heating. The boiler 8 basically has components similar to those of the water-heating device 6 of FIG. 10, and therefore the foregoing descriptions of the water-heating device 6 may be identically applied to redundant components such as a heat exchange device 84, a heating line 85, and an expansion tank 82.

Referring to the drawing, the ion removal kit 1, 2, 3, 35, or 36 is connected to an internal line 86. Based on a flow direction of water flowing along the internal line 100, the position where the water inlet opening 1001 of the ion removal kit 1, 2, 3, 35, or 36 is connected to the internal line 86 is located upward of the position where the water outlet opening 1002 is connected to the main line 86. The ion removal kit 1, 2, 3, 35, or 36 may be removably connected to the internal line 86.

Although the ion removal kit 1, 2, 3, 35, or 36 is illustrated in FIG. 12 as being disposed between the expansion tank 82 and the heating line 85, the ion removal kit 1, 2, 3, 35, or 36 may be disposed in various positions, such as between the heat exchange device 84 and the expansion tank 82, between the heat exchange device 84 and the heating line 85, and the like, as long as the ion removal kit 1, 2, 3, 35, or 36 is able to be disposed on the internal line 86. Accordingly, raw water that the ion removal kit 1, 2, 3, 35, or 36 softens is heating water that circulates in a boiler case 13 along the internal line 86.

The expansion tank 82 of the boiler 8 having the ion removal kit 1, 2, 3, 35, or 36 embedded therein may be replenished with direct water, which is to be used as heating water, through a supplementary line 81 from the outside. Accordingly, the direct water from the outside may be delivered to the ion removal kit 1, 2, 3, 35, or 36 through the internal line 86 and may be changed into soft water from which at least a part of ionic substances is removed by the ion removal kit 1, 2, 3, 35, or 36, and the soft water may circulate along the internal line 86.

As the ion removal kit 1, 2, 3, 35, or 36 disposed inside the boiler 8 softens heating water circulating in the boiler 8, the ion removal kit 1, 2, 3, 35, or 36 does not have to remove a large amount of ionic substances from the heating water at one time and removes a small amount of ionic substances every time the heating water circulates along the internal line 86, thereby providing heating water having low TDS and thus preventing occurrence of scale.

Although the ion removal kit 1, 2, 3, 35, or 36 is illustrated in FIG. 12 as being embedded in the boiler case 13, the ion removal kit 1, 2, 3, 35, or 36 according to the embodiment of the present disclosure may be connected to the heating line 85 exposed outside the boiler case 13 and may perform the same role. In this case, the ion removal kit 1, 2, 3, 35, or 36 may be removably connected to the heating line 85 and may be attached or detached as needed.

A water softening method in which the ion removal kit 1, 2, 3, 35, or 36 according to the embodiment of the present disclosure is provided in front of a consumption site, such as the water-heating device 6, the boiler system 7, or the boiler 8 described above with reference to FIG. 10, 11, or 12, and removes ionic substances from raw water that is introduced into the consumption site is referred to as a point of use (POU) water softening method. A water softening method in which an ion removal kit is installed in front of an inlet through which water is introduced into a place where consumption sites are clustered and removes, in front of the inlet, ionic substances in raw water that is supplied to all the consumption sites is referred to as a point of entry (POE) water softening method. The ion removal kit 1, 2, 3, 35, or 36 according to the embodiment of the present disclosure may be used in a POE type as well.

Soft Water Supply Method

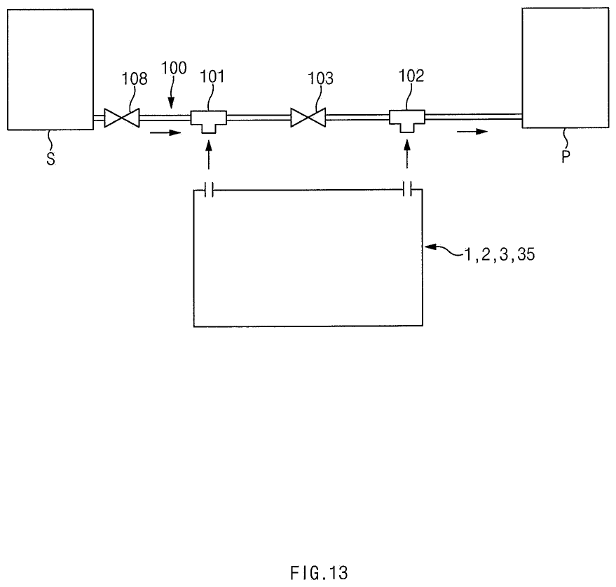

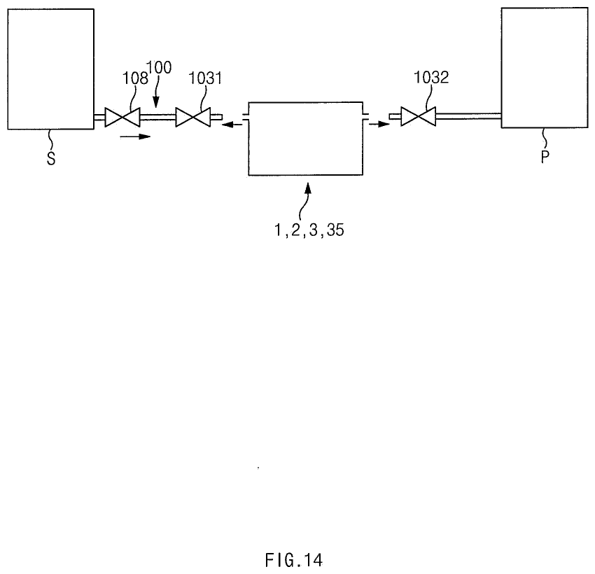

FIGS. 13 and 14 are conceptual diagrams illustrating installation processes of connecting the ion removal kit 1, 2, 3, 35, or 36 to the main line 100 according to embodiments of the present disclosure.

Soft water treatment of a water-heating device, which heats water and circulates or releases the heated water, may be performed by using the ion removal kits 1, 2, 3, 35, and 36 according to the embodiments of the present disclosure. For the soft water treatment of the water-heating device, the ion removal kits 1, 2, 3, 35, and 36 may be installed when the water-heating device is installed in a water source and may soften water supplied to the water-heating device for the first time, or may be connected to the main line 100 while the water-heating device already installed in the water source receives raw water and may supply soft water to the water-heating device.

The ion removal kits 1, 2, 3, 35, and 36 may be removed from the main line 100 after supplying sufficient soft water to the water-heating device. Alternatively, in the state of being connected to the main line 100 without being removed, the ion removal kits 1, 2, 3, 35, and 36 may supply soft water to the water-heating device every time the water-heating device needs to be replenished with water. Accordingly, the ion removal kits 1, 2, 3, 35, and 36 may be used in a fixed type, or may be used in a removable, portable type.

As illustrated in FIGS. 13 and 14, the main line 100 may connect the water source S and the water-heating device that is the consumption site P, and raw water released from the water source S may be delivered to the water-heating device. In the drawings, the water-heating device is illustrated as an example of the consumption site P. However, a consumption site P, such as a faucet, the boiler system 7 illustrated in FIG. 11, or the like, may be disposed instead of the water-heating device.

A water source valve 108 may be disposed and operated such that the raw water is released, or not released, from the water source S to the main line 100. Accordingly, when the main valve 103 is not disposed or operated, the water source valve 108 may control a flow of water flowing along the main line 100.

Two three-way valves are disposed in-line with the main line 100 of FIG. 13. Accordingly, the three-way valves connect the main line 100, and the ion removal kit 1, 2, 3, 35, or 36 is connected to the three-way valves to form a water inlet point 101 and a water outlet point 102.

The main line 100 of FIG. 14 is cut and includes a water inlet valve 1031 capable of controlling a flow of raw water entering the ion removal kit 1, 2, 3, 35, or 36 and a water outlet valve 1032 capable of controlling a flow of water released from the ion removal kit 1, 2, 3, 35, or 36.

Soft water supply methods according to embodiments of the present disclosure will be described below with reference to FIGS. 1 to 9, 13, and 14 according to an operating sequence. An installation step in which the ion removal kit 1, 2, 3, 35, or 36 is connected to the main line 100 for supplying raw water to a water-heating device is performed. However, if raw water flows through the main line 100, a step of interrupting the flow of the raw water in the main line 100 has to be performed first. Accordingly, the step of interrupting the flow of the raw water to the water-heating device through the main line 100 is performed before the installation step. The interruption step may include a step of closing the water source valve 108 in an open state that is disposed in a predetermined position of the main line 100 that is upstream of the connection position of the ion removal kit 1, 2, 3, 35, or 36 with respect to the flow direction of the raw water. However, a step in which the main valve 103 other than the water source valve 108 is closed in an open state for interruption of the raw water may be performed, the three-way valves of FIG. 14 may be used, or the water inlet valve 1031 and the water outlet valve 1032 of FIG. 14 may be used.

After the installation step, to start supply of raw water to the ion removal kit 1, 2, 3, 35, or 36, a step of starting a flow of raw water through the main line 100 may be additionally performed. If raw water has never flowed through the main line 100, the start step may be a step in which raw water flows for the first time, and if the supply of raw water to the water-heating device through the main line 100 was stopped and thereafter the ion removal kit 1, 2, 3, 35, or 36 was installed, the start step may be a step of restarting the flow of the raw water.

A preliminary step of determining whether the ion removal kit 1, 2, 3, 35, or 36 is in a state suitable to be operated may be performed before a step of generating soft water, which will be described below. The soft water supply method according to the embodiment of the present disclosure may further include, as an example of the preliminary step, a step in which a communication module included in the ion removal kit 1, 2, 3, 35, or 36 receives an identifier from the water-heating device that is used as a consumption site P. Accordingly, a step of operating the filter unit 40 of FIG. 1 to perform the soft water generation step, which will be described below, only when the ion removal kit 1, 2, 3, 35, or 36 receives an effective identifier from the water-heating device may be further included. In the state in which the ion removal kit 1, 2, 3, 35, or 36 is connected to the main line 100, a step in which the ion removal kit 1, 2, 3, 35, or 36 generates soft water containing a smaller amount of ionic substances than raw water by removing at least a part of ionic substances contained in the raw water by electro-deionization is performed.

The ion removal kit 1, 2, 3, 35, or 36 may be installed in an ex post facto manner so as to be connected to the main line 100. The expression “installed in an ex post facto manner” means that the ion removal kit 1, 2, 3, 35, or 36 is connected in a state in which both the water source S and the consumption site P, such as a water-heating device, are connected to the main line 100 or that the supply of raw water through the main line 100 connecting the water source S and the consumption site P is stopped and thereafter the ion removal kit 1, 2, 3, 35, or 36 is connected.

As described above with regard to the ion removal kit 1, 2, 3, 35, or 36, the soft water supply method according to the embodiment of the present disclosure may include a step of obtaining, by a TDS sensor, at least one of TDS of water containing soft water that is to be released from the ion removal kit 1, 2, 3, 35, or 36 or TDS of raw water that is supplied to the filter unit 40 or 352. In addition, the soft water supply method may further include a step of controlling, by the controller C, the filter unit 40 or 352 based on the obtained TDS such that the TDS of water containing soft water that is to be released from the ion removal kit 1, 2, 3, 35, or 36 is equal to or less than the reference rear TDS. A step of displaying the obtained TDS by the display included in the ion removal kit 1, 2, 3, 35, or 36 may be further included.

As described above with regard to the ion removal kit 1, 2, 3, 35, or 36, the filter unit 40 or 352 may alternately perform a removal mode for removing ionic substances by electro-deionization using the electrodes and a regeneration mode for regenerating the electrodes. In this case, the soft water supply method according to the embodiment of the present disclosure may further include a step of controlling, by the controller C, the time during which the filter unit 40 or 352 performs the removal mode, based on the TDS obtained by the front TDS sensor 315 or 356 from raw water supplied from the filter unit 40 or 352, such that the TDS of water released from the ion removal kit 1, 2, 3, 35, or 36 is equal to or less than the reference rear TDS. At this time, with an increase in the TDS obtained by the front TDS sensor 315 or 356, the controller C may reduce the time during which the filter unit 40 or 352 performs the removal mode. The reason why the TDS of water released from the ion removal kit 1, 2, 3, 35, or 36 is decreased by reducing the time during which the removal mode is performed has been described in detail in the description of FIG. 3.

The soft water supply method according to the embodiment of the present disclosure may further include a step of setting the performance time of the removal mode based on the TDS obtained and displayed as described above, such that the TDS of water released from the ion removal kit 1, 2, 3, 35, or 36 is equal to or less than the reference rear TDS. To set the performance time, the performance time may be input through the input device. As described above, with an increase in the displayed TDS, the performance time may be set to be short in the setting step.

The soft water supply method according to the embodiment of the present disclosure may further include a step of controlling, by the controller C, the flow rate of raw water flowing along the filter line 21, based on the TDS obtained by the front TDS sensor 315 or 356, such that the TDS of water released from the ion removal kit 1, 2, 3, 35, or 36 is equal to or less than the reference rear TDS. At this time, with an increase in the TDS obtained by the front TDS sensor 315 or 356, the controller C may reduce the flow rate of the raw water flowing along the filter line 21. The reason why the TDS of water released from the ion removal kit 1, 2, 3, 35, or 36 is decreased by reducing the flow rate of the raw water flowing along the filter line 21 has been described in detail in the description of FIG. 6.

The soft water supply method according to the embodiment of the present disclosure may further include a step of setting, by a valve disposed in-line with the filter line 21 or a valve disposed in-line with the main line 100, the flow rate of raw water in the filter line 21 based on the TDS obtained and displayed as described above, such that the TDS of water released from the ion removal kit 1, 2, 3, 35, or 36 is equal to or less than the reference rear TDS. To set the flow rate, the flow rate of the raw water in the filter line 21 may be input through the input device. As described above, with an increase in the displayed TDS, the flow rate of the raw water may be set to be low in the setting step.

When the ion removal kit 3 according to the third embodiment is used, the soft water supply method according to the embodiment of the present disclosure may further include a step of adjusting, by the controller C, the flow rate of raw water bypassed through the bypass line 25.

The ion removal kit 3 including the bypass line 25, as described in the third embodiment, may further include the bypass valve 332 that adjusts the flow rate of raw water bypassed through the bypass line 25 and the filter flow rate acquisition device 321 that obtains the flow rate of raw water delivered to the filter unit 40.

Accordingly, the step of adjusting the flow rate of the raw water bypassed may be a step of adjusting, by the controller C, the flow rate of the raw water bypassed through the bypass line 25 by controlling the bypass valve 332 based on the flow rate obtained by the filter flow rate acquisition device 321 such that TDS of mixed water that is formed by mixing the raw water bypassed through the bypass line 25 and soft water released from the filter unit and that is to be released through the water outlet opening 1002 is equal to or less than the reference rear TDS. A method of determining the flow rate of the bypassed raw water based on the flow rate is according to Equation 1 above.

The ion removal kit 3 including the bypass line 25, as described in the third embodiment, may further include the rear TDS sensor 331 that obtains TDS of mixed water that is formed by mixing raw water bypassed through the bypass line 25 and soft water released from the filter unit 40 and that is to be released through the water outlet opening 1002.

Accordingly, the step of adjusting the flow rate of the raw water bypassed may be a step of adjusting, by the controller C, the flow rate of the raw water bypassed through the bypass line 25 by controlling the bypass valve 332 based on the TDS obtained by the rear TDS sensor 331 such that the TDS obtained by the rear TDS sensor 331 is equal to or less than the reference rear TDS. The step of adjusting the flow rate of the bypassed raw water based on the TDS obtained by the rear TDS sensor 331 is according to Equation 2.

The soft water supply method according to the embodiment of the present disclosure may include, after the step of generating the soft water, a step of releasing, by the ion removal kit 1, 2, 3, 35, or 36, water containing the soft water from the ion removal kit 1, 2, 3, 35, or 36 to the main line 100 so as to supply the water containing the soft water to the water-heating device.

Particularly, in a case where the water-heating device 5 of FIG. 10 is used and a circulation line is formed by the internal line 61 and the heating line 66 included in the water-heating device 5, the step of generating the soft water may be a step of continually generating the soft water by the ion removal kit 1, 2, 3, 35, or 36 until water containing the soft water released from the ion removal kit 1, 2, 3, 35, or 36 replaces at least all of the existing water circulating through the circulation line. That is, when soft water continues to be produced through the ion removal kit 1, 2, 3, 35, or 36 in a state in which the drain hole 67 is open, newly produced soft water is supplied to the circulation line, and the existing water circulating through the circulation line is drained through the drain hole 67 and is replaced. The step of generating the soft water is terminated by closing the drain hole 67 and stopping operation of the ion removal kit 1, 2, 3, 35, or 36.

Even after the soft water newly generated by the ion removal kit 1, 2, 3, 35, or 36 completely replaces the existing water, soft water generated by the ion removal kit 1, 2, 3, 35, or 36 may be additionally introduced into the water-heating device for a predetermined period of time. Thereafter, the step of generating the raw water is terminated by closing the drain hole 67 and stopping operation of the ion removal kit 1, 2, 3, 35, or 36.

A drain pump (not illustrated) may be additionally disposed in-line with the internal line 61 of the water-heating device 5 of FIG. 10, and existing water flowing in the internal line 61 may be drained to the outside through the drain hole 67, or may be drained to the outside through a pipe connected to the drain pump, by pressure of the drain pump. After the existing water is drained, soft water generated by the ion removal kit 1, 2, 3, 35, or 36 may be introduced into the internal line 61 to replace existing water.

A method of installing and operating the ion removal kit 1, 2, 3, 35, or 36 according to the embodiment of the present disclosure to supply soft water may be performed by an operator. When raw water is supplied to the water-heating device through the main line 100 connecting the water-heating device, which is the consumption site S, and the water source S, the operator interrupts the flow of the raw water by operating a valve disposed in-line with the main line 100. The valve may be, but is not limited to, the water source valve 108 or the main valve 103.

In a state in which raw water has never been supplied, or the flow of the raw water is interrupted through the above-described process, the operator connects the ion removal kit 1, 2, 3, 35, or 36 to the main line 100. After the connection of the ion removal kit 1, 2, 3, 35, or 36, the operator may operate the above-described valve to allow raw water to start to flow along the main line 100.

As the raw water is supplied to the main line 100 and the ion removal kit 1, 2, 3, 35, or 36, the operator may set an operating state of the ion removal kit 1, 2, 3, 35, or 36 by using various pieces of information obtained through a trial run.

The operator may identify the TDS of the raw water displayed through the display and may input and set, through the input device, performance time of a removal mode that corresponds to the relevant TDS and that allows TDS of water released from the ion removal kit 1, 2, 3, 35, or 36 to be equal to or less than the reference rear TDS.

The operator may set the flow rate of the raw water flowing along the filter line 21 that corresponds to the relevant TDS, by operating a valve disposed in-line with the filter line 21 or the main line 100.

When the ion removal kit 3 including the bypass line 25 is installed, the operator may supply water having TDS equal to or less than the reference rear TDS to the water-heating device by adjusting a bypassed flow rate. In this case, the operator may obtain the flow rate of the raw water to be bypassed that is obtained based on the flow rate flowing along the filter line 21 that is displayed on the display, such that TDS of mixed water to be released through the water outlet opening 1002 is equal to or less than the reference rear TDS. The operator may operate the bypass valve 332 to adjust the flow rate of the raw water to be bypassed along the bypass line 21.

The operator may obtain the flow rate of the raw water to be bypassed that is obtained based on the TDS that is obtained by the rear TDS sensor 331 and is displayed on the display, such that the TDS of mixed water to be released through the water outlet opening 1002 is equal to or less than the reference rear TDS. The operator may operate the bypass valve 332 to adjust the flow rate of the raw water to be bypassed along the bypass line 21.

The operator may set an operating state of the ion removal kit 1, 2, 3, 35, or 36 by using at least one of the above-described setting steps and may operate the ion removal kit 1, 2, 3, 35, or 36 to supply water having TDS equal to or less than the reference rear TDS to the water-heating device. The operator may release existing water from the circulation line of the water-heating device and may replace existing water filling the circulation line with water produced by the ion removal kit 1, 2, 3, 35, or 36.

Thereafter, the operator may remove the ion removal kit 1, 2, 3, 35, or 36 from the main line 100 in a state of interrupting the flow of the raw water by operating the valve disposed in-line with the main line 100. After the ion removal kit 1, 2, 3, 35, or 36 is removed, the operator may restart a flow of raw water by operating the valve disposed in-line with the main line 100.

However, in a case where the ion removal kit 1, 2, 3, 35, or 36 is connected to the boiler system 7 of FIG. 11 instead of the water-heating device, it is necessary to consistently supply water containing soft water. Accordingly, unless there is a problem such as replacement or breakdown, the ion removal kit 1, 2, 3, 35, or 36 connected to the boiler system 7 may not be separated from the main line 100 and may operate to produce and release soft water when the supplementary tank 50 needs to be replenished with water.

For a water-heating device that does not have a means for removing ionic substances of water located inside, occurrence of scale may be prevented by performing a method of simply installing, operating, and removing the ion removal kit 1, 2, 3, 35, or 36.

Hereinabove, even though all of the components are coupled into one body or operate in a combined state in the description of the above-mentioned embodiments of the present disclosure, the present disclosure is not limited to these embodiments. That is, all of the components may operate in one or more selective combination within the range of the purpose of the present disclosure. It should be also understood that the terms of “include”, “comprise” or “have” in the specification are “open type” expressions just to say that the corresponding components exist and, unless specifically described to the contrary, do not exclude but may include additional components. Unless otherwise defined, all terms used herein, including technical and scientific terms, have the same meaning as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

1. An ion removal kit comprising:
a kit case;
a filter unit provided inside the kit case, wherein the filter unit receives raw water from a main line configured to supply the raw water to a consumption site, removes at least a part of ionic substances contained in the received raw water by electro-deionization, and releases soft water containing a smaller amount of ionic substances than the raw water;
a filter line provided inside the kit case and configured to connect the filter unit and a water inlet opening that is formed in the kit case and through which the raw water is supplied;
a water outlet line provided inside the kit case and configured to connect the filter unit and a water outlet opening that is formed in the kit case and through which the soft water is delivered to the main line; and
a controller provided inside the kit case and configured to control the filter unit.

2. The ion removal kit of claim 1, further comprising:
a bypass line connected to the water inlet opening and the water outlet opening and configured to selectively bypass, to the water outlet opening, at least part of the raw water that is supplied through the water inlet opening and that is to be supplied to the filter unit.

3. The ion removal kit of claim 1, wherein the water inlet opening and the water outlet opening are removably connected to the main line or connecting pipes connected with the main line.

4. The ion removal kit of claim 1, further comprising:
connecting pipes connected to the water inlet opening and the water outlet opening, respectively, and removably connected to the main line.

5. The ion removal kit of claim 1, wherein the controller controls the filter unit, based on a state of the raw water introduced through the water inlet opening or a state of water that is to be released through the water outlet opening.

6. The ion removal kit of claim 1, further comprising:
a TDS sensor configured to obtain at least one of total dissolved solids (TDS) of the raw water that is supplied to the filter unit or TDS of water that is to be released through the water outlet opening,
wherein based on the TDS obtained by the TDS sensor, the controller controls the filter unit such that the TDS of the water that is released through the water outlet opening is equal to or less than reference rear TDS.

7. The ion removal kit of claim 1, further comprising:
a front TDS sensor configured to obtain total dissolved solids (TDS) of the raw water delivered to the filter unit,
wherein the filter unit alternately performs a removal mode for removing the ionic substances by the electro-deionization through electrodes and a regeneration mode for regenerating the electrodes, and
wherein based on the TDS obtained by the front TDS sensor, the controller controls time during which the filter unit performs the removal mode, such that TDS of water that is released through the water outlet opening is equal to or less than reference rear TDS.

8. The ion removal kit of claim 7, wherein with an increase in the TDS obtained by the front TDS sensor, the controller reduces the time during which the filter unit performs the removal mode.

9. The ion removal kit of claim 7, further comprising:
a constant flow rate valve configured to maintain a flow rate of the raw water flowing through the filter line at a first flow rate by adjusting a degree to which the filter line is open.

10. The ion removal kit of claim 1, further comprising:
a front TDS sensor configured to obtain total dissolved solids (TDS) of the raw water delivered to the filter unit,
wherein based on the TDS obtained by the front TDS sensor, the controller controls a flow rate of the raw water flowing along the filter line, such that TDS of water that is released through the water outlet opening is equal to or less than reference rear TDS.

11. The ion removal kit of claim 10, wherein with an increase in the TDS obtained by the front TDS sensor, the controller decreases the flow rate of the raw water flowing along the filter line.

12. The ion removal kit of claim 10, further comprising:
a flow rate control valve controlled by the controller and configured to adjust the flow rate of the raw water flowing through the filter line by adjusting a degree to which the filter line is open.

13. The ion removal kit of claim 1, further comprising:
a pressure acquisition device configured to obtain internal pressure of the filter line,
wherein the controller operates the filter unit when the internal pressure of the filter line obtained by the pressure acquisition device is lower than a first pressure, the first pressure being internal pressure of the filter line when the supply of the raw water to the consumption site is interrupted.

14. The ion removal kit of claim 1, further comprising:
a filter flow rate acquisition device configured to obtain a flow rate of the raw water flowing through the filter line,
wherein the controller operates the filter unit when the flow rate of the raw water flowing through the filter line exceeds 0, the flow rate being obtained by the filter flow rate acquisition device.

15. The ion removal kit of claim 2, further comprising:
a bypass valve configured to control a flow rate of the raw water bypassed through the bypass line and a filter flow rate acquisition device configured to obtain a flow rate of the raw water delivered to the filter unit,
wherein the controller adjusts the flow rate of the raw water bypassed through the bypass line, by controlling the bypass valve based on the flow rate obtained by the filter flow rate acquisition device such that total dissolved solids (TDS) of mixed water is equal to or less than reference rear TDS, wherein the mixed water is formed by mixture of the raw water bypassed through the bypass line and the soft water released from the filter unit and is released through the water outlet opening.

16. The ion removal kit of claim 2, further comprising:
a bypass valve configured to control a flow rate of the raw water bypassed through the bypass line and a rear TDS sensor configured to obtain TDS of mixed water that is formed by mixture of the raw water bypassed through the bypass line and the soft water released from the filter unit and that is to be released through the water outlet opening,
wherein the controller adjusts the flow rate of the raw water bypassed through the bypass line, by controlling the bypass valve based on the TDS obtained by the rear TDS sensor such that the TDS obtained by the rear TDS sensor is equal to or less than the reference rear TDS.

17. An ion removal kit comprising:
a kit case;
a filter unit provided inside the kit case, wherein the filter unit receives raw water from a main line configured to supply the raw water to a water-heating device configured to heat water and circulate or release the heated water, removes at least a part of ionic substances contained in the received raw water by electric force, and releases soft water containing a smaller amount of ionic substances than the raw water;
a filter line provided inside the kit case and configured to connect the filter unit and a water inlet opening that is formed in the kit case and through which the raw water is supplied;
a water outlet line provided inside the kit case and configured to connect the filter unit and a water outlet opening that is formed in the kit case and through which the soft water is delivered to the main line; and
a controller provided inside the kit case and configured to control the filter unit.

18. An ion removal kit comprising:
a kit case;
a filter unit provided inside the kit case, wherein the filter unit receives heating water from an internal line provided inside a boiler configured to provide heating by heating and circulating water, removes at least a part of ionic substances contained in the received heating water by electric force, and releases soft water containing a smaller amount of ionic substances than the heating water, and the internal line, together with a heating line configured to provide heating to an object to be heated, forms a circulation line through which the heating water circulates;
a filter line provided inside the kit case and configured to connect the filter unit and a water inlet opening that is formed in the kit case and through which the heating water is supplied;
a water outlet line provided inside the kit case and configured to connect the filter unit and a water outlet opening that is formed in the kit case and through which the soft water is delivered to the main line; and
a controller provided inside the kit case and configured to control the filter unit.

19. The ion removal kit of claim 2, wherein the water inlet opening and the water outlet opening are removably connected to the main line or connecting pipes connected with the main line.

20. The ion removal kit of claim 2, further comprising:
connecting pipes connected to the water inlet opening and the water outlet opening, respectively, and removably connected to the main line.
